(19) United States
(12) Patent Application Publication
(10) Pub. No.: US 2026/0097906 A1
(43) Pub. Date: Apr. 9, 2026

(54) FEEDING APPARATUS AND FEEDING METHOD

(71) Applicant: Tyco Electronics (Shanghai) Co., Ltd., Shanghai (CN)

(72) Inventors: Liao (Leo) Chen, Shanghai (CN); Xianghao (Jorge) Bao, Shanghai (CN); Dandan (Emily) Zhang, Shanghai (CN)

(73) Assignee: Tyco Electronics (Shanghai) Co., Ltd., Shanghai (CN)

(21) Appl. No.: 19/352,559

(22) Filed: Oct. 8, 2025

(30) Foreign Application Priority Data
Oct. 9, 2024 (CN) 202411411250.4

(51) Int. Cl. B65G 47/14; B25J 9/00; B65G 1/04; B65G 1/137

(52) U.S. Cl. CPC B65G 47/1407; B65G 1/045; B65G 1/137; B25J 9/0096; B65G 2203/0283; B65G 2203/041; B65G 2812/03

(57) ABSTRACT

A feeding apparatus includes a vibrating device having a plurality of vibrating regions spaced apart in a circumferential direction and a plurality of feeders disposed at a feeding station and respectively accommodating a plurality of different types of components. The plurality of vibrating regions of the vibrating device are rotatable about an axis in sequence to the feeding station. When one vibrating region of the plurality of vibrating regions is rotated to the feeding station, a component in one feeder corresponding to the one vibrating region is supplied into the one vibrating region. The vibrating device adjusts the component located in the one vibrating region by vibration to a predetermined posture suitable for being captured by a robot.

### CROSS-REFERENCE TO RELATED APPLICATIONS

This application claims the benefit of the filing date under 35 U.S.C. § 119 (a)-(d) of Chinese Patent Application No. 202411411250.4, filed on Oct. 9, 2024.

### FIELD OF THE INVENTION

The present invention relates to a feeding apparatus and a feeding method adapted to supply a plurality of different types of components simultaneously.

### BACKGROUND

A feeding apparatus typically can only supply the same type of components at the same time. If a plurality of different types of components need to be supplied at the same time, a plurality of different types of feeding apparatuses need to be provided. This not only increases production costs, but also requires a large amount of space.

### SUMMARY

A feeding apparatus includes a vibrating device having a plurality of vibrating regions spaced apart in a circumferential direction and a plurality of feeders disposed at a feeding station and respectively accommodating a plurality of different types of components. The plurality of vibrating regions of the vibrating device are rotatable about an axis in sequence to the feeding station. When one vibrating region of the plurality of vibrating regions is rotated to the feeding station, a component in one feeder corresponding to the one vibrating region is supplied into the one vibrating region. The vibrating device adjusts the component located in the one vibrating region by vibration to a predetermined posture suitable for being captured by a robot.

### BRIEF DESCRIPTION OF DRAWINGS

In the following, the present invention is described in more detail with reference to the drawings in which:

FIG. 1 shows an illustrative perspective view of a feeding system according to an exemplary embodiment of the present invention;

FIG. 2 shows an illustrative perspective view of a rotating disc and vibrating plates of a vibrating device of a feeding system according to an exemplary embodiment of the present invention;

FIG. 3 shows a top view of a feeding system according to an exemplary embodiment of the present invention, in which a first vibrating region is rotated to a feeding station;

FIG. 4 shows a top view of a feeding system according to an exemplary embodiment of the present invention, in which a first feeder supplies a first type of component into a first vibrating region;

FIG. 5 shows a top view of a feeding system according to an exemplary embodiment of the present invention, in which a second vibrating region is rotated to a feeding station;

FIG. 6 shows a top view of a feeding system according to an exemplary embodiment of the present invention, in which a second feeder supplies a second type of component into a second vibrating region;

FIG. 7 shows a top view of a feeding system according to an exemplary embodiment of the present invention, in which a third vibrating region is rotated to the feeding station;

FIG. 8 shows a top view of a feeding system according to an exemplary embodiment of the present invention, in which a third feeder supplies a third type of component into a third vibrating region;

FIG. 9 shows a top view of a feeding system according to an exemplary embodiment of the present invention, in which a fourth vibrating region is rotated to a feeding station; and

FIG. 10 shows a top view of a feeding system according to an exemplary embodiment of the present invention, in which a fourth feeder supplies a fourth type of component into a fourth vibrating region.

### DETAILED DESCRIPTION OF THE EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

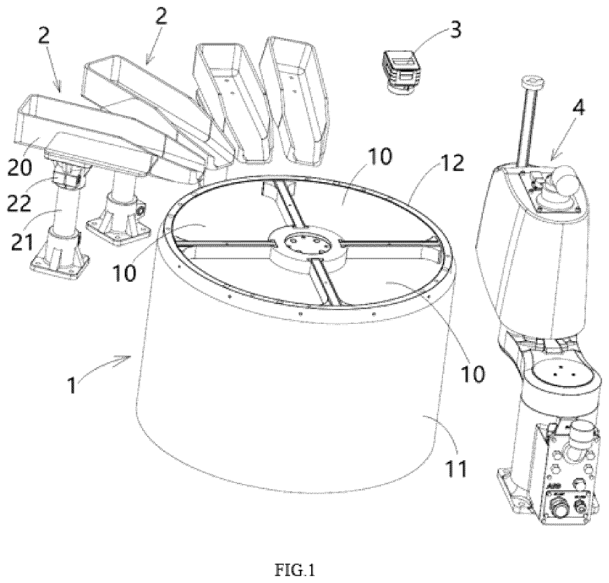

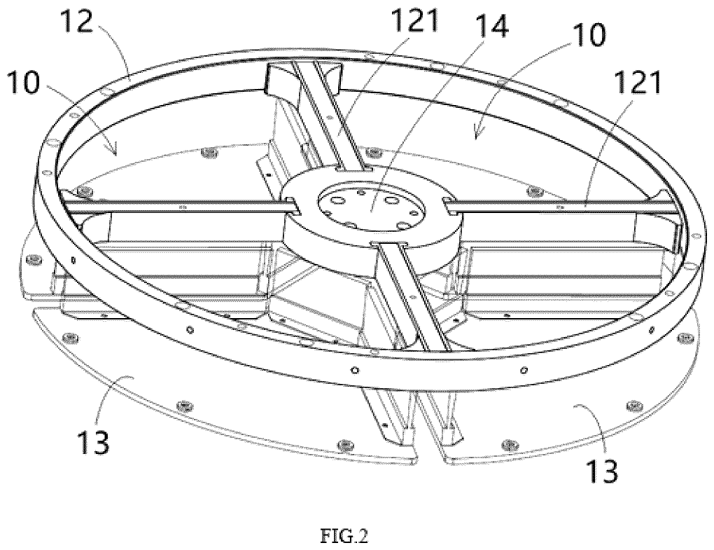

In the exemplary embodiment and as shown in FIGS. 1 to 10, a feeding apparatus is disclosed. The feeding apparatus comprises: a vibrating device 1 and a plurality of feeders 2. The vibrating device 1 has a plurality of vibrating regions 10 spaced apart in a circumferential direction thereof. The plurality of feeders 2 are disposed at a feeding station and are configured to accommodate a plurality of different types of components 5 respectively. The plurality of vibrating regions 10 of the vibrating device 1 are rotatable about an axis such that the plurality of vibrating regions 10 are capable of being rotated in sequence to the feeding station. When one vibrating region 10 of the plurality of vibrating regions 10 is rotated to the feeding station, a component 5 in one feeder 2 corresponding to the one vibrating region 10 is supplied into the one vibrating region 10. The vibrating device 1 is adapted to adjust the component 5 located in the vibrating region 10 by vibration to a predetermined posture suitable for being captured by a robot 4.

In the exemplary embodiment and as shown in FIGS. 1 to 10, in the illustrated embodiment, the components 5 may be electronic devices or other parts, such as chips.

In the exemplary embodiment and as shown in FIGS. 1 to 10, in the illustrated embodiment, the plurality of feeders 2 are independent of each other, the same feeder 2 is configured to supply the same type of components 5, and the plurality of feeders 2 are configured to supply the plurality of different types of components 5. The plurality of vibrating regions 10 are independent of each other, the same vibrating region 10 is configured to vibrate the same type of components 5, and the plurality of vibrating regions 10 are configured to vibrate the plurality of different types of components 5.

In the exemplary embodiment and as shown in FIGS. 1 to 10, in the illustrated embodiment, the plurality of feeders 2 are arranged in sequence around a periphery of the vibrating device 1 and adjacent to each other, and the plurality of feeders 2 are in one-to-one correspondence with the plurality of vibrating regions 10.

In the exemplary embodiment and as shown in FIGS. 1 to 10, in the illustrated embodiment, the feeding apparatus further comprises: a vision device 3 and a control device. The vision device 3 is disposed above the vibrating device 1 and is configured to detect whether there is a component 5 in the vibrating region 10 and whether the vibrating region 10 has been rotated to the feeding station. The control device is configured to control the feeder 2 to supply the component 5 into the vibrating region 10 based on a detection result of the vision device 3. When the vision device 3 detects that there is no component 5 in one vibrating region 10 rotated to the feeding station, the control device controls one feeder 2 corresponding to the one vibrating region 10 to supply into the one vibrating region 10 a type of component(s) 5 corresponding to the one vibrating region 10.

In the exemplary embodiment and as shown in FIGS. 1 to 10, in the illustrated embodiment, the feeder 2 comprises: a support 21, a hopper 20 and a driving device 22. The hopper 20 is configured to load the component(s) 5 and is rotatably mounted on the support 21. The driving device 22 is mounted on the support 21. The driving device 22 is adapted to drive the hopper 20 to a discharge position under the control of the control device so as to discharge the component(s) 5 in the hopper 20 into a corresponding vibrating region 10.

In the exemplary embodiment and as shown in FIGS. 1 to 10, in the illustrated embodiment, the feeder 2 further comprises a reset spring connected between the hopper 20 and the support 21 and configured to automatically reset the hopper 20 from the discharge position to an initial position.

In the exemplary embodiment and as shown in FIGS. 1 to 10, in the illustrated embodiment, the vibrating device 1 comprises a plurality of vibrating plates 13 located in the plurality of vibrating regions 10 respectively. The plurality of vibrating plates 13 are adapted to individually vibrate under the control of the control device such that the component(s) 5 in each vibrating region 10 is (are) adjusted to a predetermined posture under the vibration of a corresponding vibrating plate 13.

In the exemplary embodiment and as shown in FIGS. 1 to 10, in the illustrated embodiment, the vibrating device 1 further comprises a body 11, a rotating disc 12 and a driver 14. The rotating disc 12 is rotatably mounted on the body 11 and is rotatable about an axis thereof. The driver 14 is mounted in the body 11 and is connected to the rotating disc 12, and the driver 14 is configured to drive the rotating disc 12 to rotate. A plurality of radial partition ribs 121 are formed in the rotating disc 12, and the plurality of radial partition ribs 121 are spaced apart in a circumferential direction of the rotating disc 12 to divide the rotating disc 12 into the plurality of vibrating regions 10. The plurality of vibrating plates 13 are mounted at a bottom of the rotating disc 12 and are located in the plurality of vibrating regions 10, respectively.

In the exemplary embodiment and as shown in FIGS. 1 to 10, in the illustrated embodiment, the feeding apparatus further comprises the robot 4. The robot 4 is mounted at a capturing station for capturing the component(s) 5 in the predetermined posture from the vibrating region 10 of the vibrating device 1. The plurality of vibrating regions 10 of the vibrating device 1 are capable of being rotated in sequence to the capturing station, and the robot 4 is capable of capturing the component(s) 5 in the vibrating region 10 rotated to the capturing station.

In the exemplary embodiment and as shown in FIGS. 1 to 10, in the illustrated embodiment, the vision device 3 is further configured to detect whether the vibrating region 10 has been rotated to the capturing station and to identify position and posture of the component(s) 5 in the vibrating region 10 rotated to the capturing station. The robot 4 is adapted to capture the component(s) 5 in the predetermined posture from the vibrating region 10 rotated to the capturing station under visual guidance of the vision device 3.

In the exemplary embodiment and as shown in FIGS. 1 to 10, in another exemplary embodiment of the present invention, a feeding method is disclosed. The feeding method comprises the following steps:
S10: providing the aforementioned feeding apparatus;
S20: loading a plurality of different types of components 5 into a plurality of feeders 2, respectively;
S30: rotating one vibrating region 10 to a feeding station;
S40: controlling one feeder 2 corresponding to the one vibrating region 10 to supply into the one vibrating region 10 a type of component(s) 5 corresponding to the one vibrating region 10; S50: rotating another vibrating region 10 to the feeding station; and
S60: controlling another feeder 2 corresponding to the another vibrating region 10 to supply into the another vibrating region 10 another type of component(s) 5 corresponding to the another vibrating region 10.

In the exemplary embodiment, the plurality of vibrating regions 10 of the vibrating device 1 are rotated in sequence to the feeding station to supply the plurality of different types of components 5 in the plurality of feeders 2 into the plurality of vibrating regions 10 of the vibrating device 1, respectively.

In the exemplary embodiment and as shown in FIGS. 1 to 10, in the illustrated embodiment, when a vision device 3 detects that there is a component 5 in one vibrating region 10 rotated to a capturing station and no component 5 is in a predetermined posture, the control device controls one vibrating plate 13 corresponding to the one vibrating region 10 to vibrate, so as to adjust the component 5 in the one vibrating region 10 to the predetermined posture by means of vibration.

In the exemplary embodiment and as shown in FIGS. 1 to 10, in the illustrated embodiment, when the vision device 3 identifies that component 5 in one vibrating region 10 rotated to the capturing station has been adjusted to the predetermined posture, the control device controls one vibrating plate 13 corresponding to the one vibrating region 10 to stop vibrating and controls a robot 4 to capture the component 5 in the predetermined posture from the one vibrating region 10 under the visual guidance of the vision device 3.

In the exemplary embodiment and as shown in FIGS. 1 to 10, in the illustrated embodiment, when the vision device 3 detects that there is no component 5 in one vibrating region 10 rotated to the capturing station or that the component(s) 5 has (have) been captured by the robot 4, the control device controls the one vibrating region 10 to be rotated to the feeding station again, so as to supply another component(s) 5 into the one vibrating region 10.

In the exemplary embodiment and as shown in FIGS. 1 to 10, in the illustrated embodiment, a feeding operation of the feeder 2 and a capturing operation of the robot 4 are performed simultaneously. In this way, production efficiency can be improved. The feeding process of the feeding apparatus shown in the figures will be explained in detail below with reference to FIGS. 1 to 10.

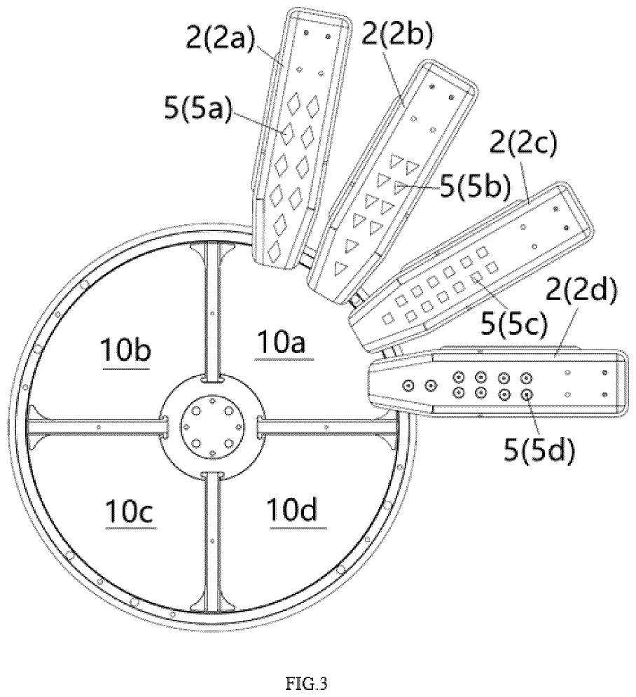

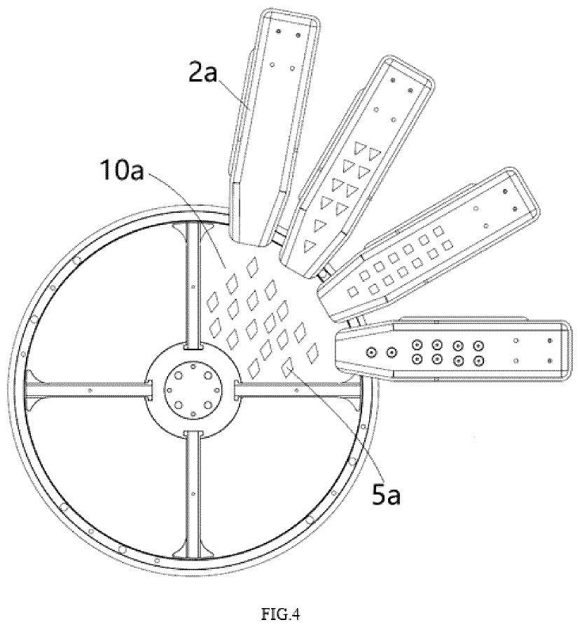

In the exemplary embodiment and as shown in FIGS. 3 and 4, a first vibrating region 10a is rotated to the feeding station, and a first feeder 2a corresponding to the first vibrating region 10a is controlled to supply into the first vibrating region 10a a first type of component(s) 5a corresponding to the first vibrating region 10a.

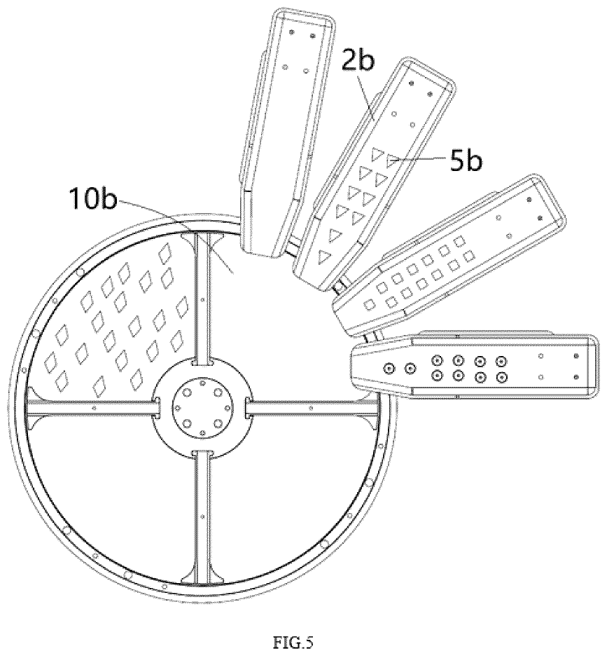

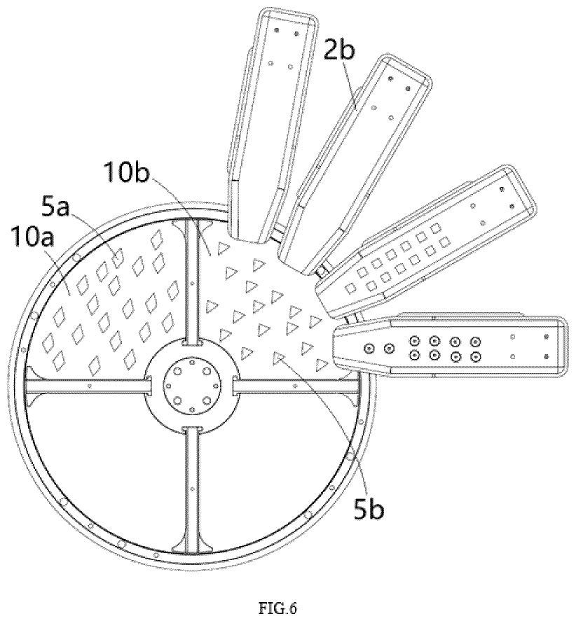

In the exemplary embodiment and as shown in FIGS. 5 and 6, a second vibrating region 10b is rotated to the feeding station, and a second feeder 2b corresponding to the second vibrating region 10b is controlled to supply into the second vibrating region 10b a second type of component(s) 5b corresponding to the second vibrating region 10b.

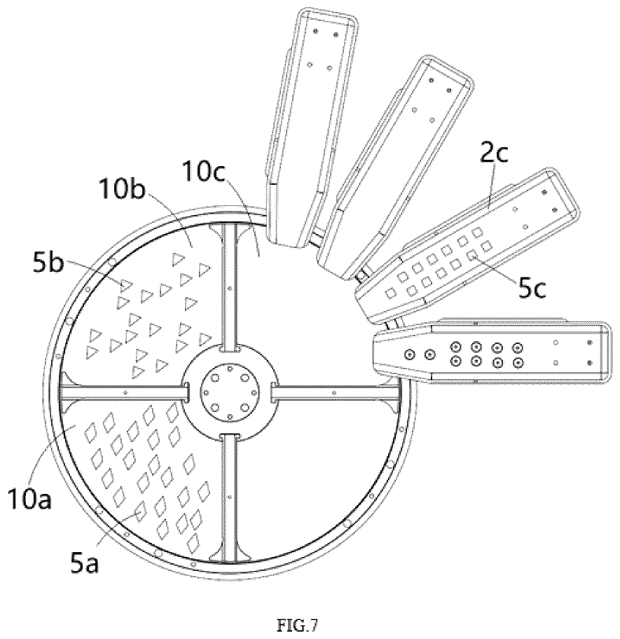

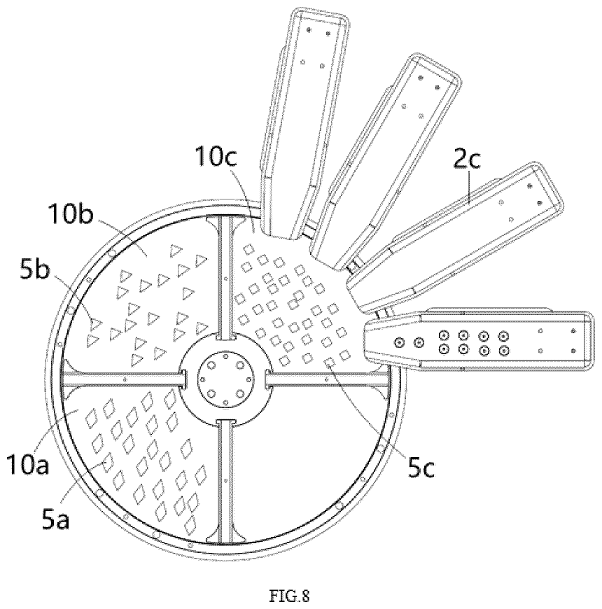

In the exemplary embodiment and as shown in FIGS. 7 and 8, a third vibrating region 10c is rotated to the feeding station, and a third feeder 2c corresponding to the third vibrating region 10c is controlled to supply into the third vibrating region 10c a third type of component(s) 5c corresponding to the third vibrating region 10c.

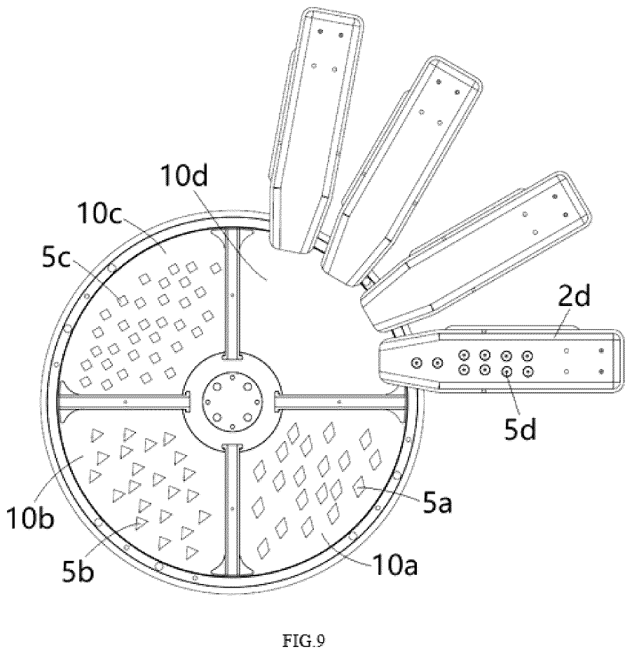

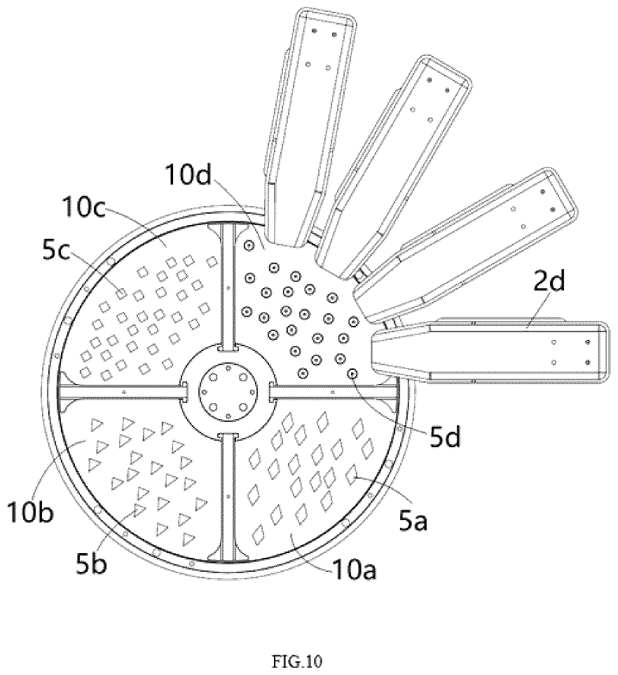

In the exemplary embodiment and as shown in FIGS. 9 and 10, a fourth vibrating region 10d is rotated to the feeding station, and a fourth feeder 2d corresponding to the fourth vibrating region 10d is controlled to supply into the fourth vibrating region 10d a fourth type of component(s) 5d corresponding to the fourth vibrating region 10d.

In the aforementioned exemplary embodiments according to the present invention, the same feeding apparatus can supply a plurality of different types of components simultaneously without needing to provide a plurality of different types of feeding apparatuses, which greatly reduces production costs, and can also reduce the size of the feeding apparatus, thereby saving the space required by the feeding apparatuses.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A feeding apparatus, comprising:
a vibrating device having a plurality of vibrating regions spaced apart in a circumferential direction; and
a plurality of feeders disposed at a feeding station and respectively accommodating a plurality of different types of components, the plurality of vibrating regions of the vibrating device are rotatable about an axis in sequence to the feeding station, when one vibrating region of the plurality of vibrating regions is rotated to the feeding station, a component in one feeder corresponding to the one vibrating region is supplied into the one vibrating region, the vibrating device adjusts the component located in the one vibrating region by vibration to a predetermined posture suitable for being captured by a robot.

2. The feeding apparatus of claim 1, wherein the plurality of feeders are independent of each other, the same feeder is configured to supply the same type of components, and the plurality of feeders are configured to supply the plurality of different types of components.

3. The feeding apparatus of claim 2, wherein the plurality of vibrating regions are independent of each other, the same vibrating region is configured to vibrate the same type of components, and the plurality of vibrating regions are configured to vibrate the plurality of different types of components.

4. The feeding apparatus of claim 1, wherein the plurality of feeders are arranged in sequence around a periphery of the vibrating device and adjacent to each other, and the plurality of feeders are in one-to-one correspondence with the plurality of vibrating regions.

5. The feeding apparatus of claim 1, further comprising a vision device disposed above the vibrating device and configured to detect whether the component is in the one vibrating region and whether the one vibrating region has been rotated to the feeding station.

6. The feeding apparatus of claim 5, further comprising a control device configured to control a feeder to supply the component into the one vibrating region based on a detection result of the vision device.

7. The feeding apparatus of claim 6, wherein, when the vision device detects that there is no component in the one vibrating region rotated to the feeding station, the control device controls one feeder corresponding to the one vibrating region to supply into the one vibrating region a type of component corresponding to the one vibrating region.

8. The feeding apparatus of claim 7, wherein the one feeder has a support and a hopper configured to load the component and rotatably mounted on the support.

9. The feeding apparatus of claim 8, wherein the one feeder has a driving device mounted on the support.

10. The feeding apparatus of claim 9, wherein the driving device drives the hopper to a discharge position under control of the control device so as to discharge the component in the hopper into a corresponding vibrating region.

11. The feeding apparatus of claim 10, wherein the feeder further comprises a reset spring connected between the hopper and the support and configured to automatically reset the hopper from the discharge position to an initial position.

12. The feeding apparatus of claim 7, wherein the vibrating device comprises a plurality of vibrating plates located in the plurality of vibrating regions respectively, wherein the plurality of vibrating plates are adapted to individually vibrate under the control of the control device such that the component in each vibrating region is adjusted to the predetermined posture under the vibration of a corresponding vibrating plate.

13. The feeding apparatus of claim 12, wherein the vibrating device further comprises a body, a rotating disc rotatably mounted on the body and rotatable about an axis thereof, and a driver mounted in the body and connected to the rotating disc, the driver drives the rotating disc to rotate, a plurality of radial partition ribs are formed in the rotating disc, the plurality of radial partition ribs are spaced apart in a circumferential direction of the rotating disc to divide the rotating disc into the plurality of vibrating regions, the plurality of vibrating plates are mounted at a bottom of the rotating disc and are respectively located in the plurality of vibrating regions.

14. The feeding apparatus of claim 7, further comprising the robot mounted at a capturing station for capturing the component in the predetermined posture from the one vibrating region of the vibrating device, the plurality of vibrating regions of the vibrating device are rotatable in sequence to the capturing station, the robot captures the component in the one vibrating region rotated to the capturing station.

15. The feeding apparatus of claim 14, wherein the vision device detects whether the one vibrating region has been rotated to the capturing station and identifies position and posture of the component in the one vibrating region rotated to the capturing station, the robot captures the component in the predetermined posture from the one vibrating region rotated to the capturing station under visual guidance of the vision device.

16. A feeding method, comprising the following steps:
providing a feeding apparatus;
loading a plurality of different types of components into a plurality of feeders, respectively;
rotating one vibrating region to a feeding station;
controlling one feeder corresponding to one vibrating region to supply into the one vibrating region a type of component corresponding to the one vibrating region;
rotating another vibrating region to the feeding station; and
controlling another feeder corresponding to an another vibrating region to supply into the another vibrating region another type of component corresponding to the another vibrating region, a plurality of vibrating regions of a vibrating device are rotated in sequence to the feeding station to supply the plurality of different types of components in the plurality of feeders into the plurality of vibrating regions of the vibrating device, respectively.

17. The feeding method of claim 16, wherein, when a vision device detects that there is a component in the one vibrating region rotated to a capturing station and no component is in a predetermined posture, a control device controls one vibrating plate corresponding to the one vibrating region to vibrate, so as to adjust the component in the one vibrating region to the predetermined posture.

18. The feeding method of claim 17, wherein, when the vision device identifies that the component in the one vibrating region rotated to the capturing station has been adjusted to the predetermined posture, the control device controls one vibrating plate corresponding to the one vibrating region to stop vibrating and controls a robot to capture the component in the predetermined posture from the one vibrating region under a visual guidance of the vision device.

19. The feeding method of claim 18, wherein, when the vision device detects that there is no component in the one vibrating region rotated to the capturing station or that the component has been captured by the robot, the control device controls the one vibrating region to be rotated to the feeding station again, so as to supply another component into the one vibrating region.

20. The feeding method of claim 18, wherein a feeding operation of a feeder and a capturing operation of the robot are performed simultaneously.
